(19) United States
(12) Patent Application Publication
(10) Pub. No.: US 2025/0253531 A1
(43) Pub. Date: Aug. 7, 2025

(54) ANTENNA FOR TRANSMITTING AND RECEIVING ULTRA-WIDE BAND SIGNAL AND ELECTRONIC DEVICE INCLUDING THE ANTENNA

(71) Applicants: HONGIK UNIVERSITY INDUSTRY-ACADEMIA COOPERATION FOUNDATION, Seoul (KR); KOOKMIN UNIVERSITY INDUSTRY ACADEMY COOPERATION FOUNDATION, Seoul (KR)

(72) Inventors: Sangwoon YOUN, Seoul (KR); Eunjung KANG, Seoul (KR); Hosung CHOO, Seoul (KR); Byung-Jun JANG, Seoul (KR)

(73) Assignees: HONGIK UNIVERSITY INDUSTRY-ACADEMIA COOPERATION FOUNDATION, Seoul (KR); KOOKMIN UNIVERSITY INDUSTRY ACADEMY COOPERATION FOUNDATION, Seoul (KR)

(21) Appl. No.: 18/961,924

(22) Filed: Nov. 27, 2024

(30) Foreign Application Priority Data
Feb. 7, 2024 (KR) 10-2024-0019179
Jul. 23, 2024 (KR) 10-2024-0097463

(51) Int. Cl. H01Q 9/04; H01Q 1/42; H01Q 13/18

(52) U.S. Cl. CPC H01Q 9/0407; H01Q 1/422; H01Q 13/18

(57) ABSTRACT

Provided is an antenna and an electronic device including the antenna. The antenna according to an embodiment of the disclosure includes: a first radiator having a patch shape; a plurality of feed structures configured to feed the first radiator; and a plurality of ports connected to the plurality of feed structures, respectively, wherein each of the plurality of feed structures includes an L-shaped microstrip line.

### CROSS-REFERENCE TO RELATED APPLICATIONS

This application is based on and claims priority under 35 U.S.C. § 119 to Korean Patent Application Nos. 10-2024-0019179, filed on Feb. 7, 2024, and 10-2024-0097463, filed on Jul. 23, 2024, in the Korean Intellectual Property Office, the disclosures of which are incorporated by reference herein in their entireties.

### BACKGROUND

### 1. Field

The disclosure relates to an antenna configured to transmit and receive ultra-wide band (UWB) signals. Specifically, the disclosure relates to a UWB direction finding technology that is free from limitations in antenna size.

This research was conducted with support from the Samsung Future Technology Promotion Project (Project Number: SRFC-IT1801-51).

### 2. Description of the Related Art

Ultra-wide band (UWB) signals are pulses with a narrow width in the time domain. According to the definition of the U.S. Federal Communications Commission (FCC), UWB signals use a frequency bandwidth of 500 MHz or more. UWB technology relating to transmission and reception of UWB signals has a much wider band width than previous wireless communication technologies in the frequency domain.

UWB technology may be used to establish wireless communication between electronic devices. UWB technology may be used to build a short-range wireless personal communication network. In addition, UWB technology may measure where ultra-wideband signals are transmitted. Accordingly, a direction finding technology may be implemented by using UWB technology.

A direction finding technology using a previous UWB technology uses a method of measuring a phase difference in an arrival path of radio waves received from an antenna. When measuring the phase difference in the arrival path of radio waves received from an antenna, a size of the antenna is set to a certain value or more. Accordingly, it is not easy to miniaturize an electronic device including the antenna.

### SUMMARY

Additional aspects will be set forth in part in the description which follows and, in part, will be apparent from the description, or may be learned by practice of the presented embodiments of the disclosure.

According to an aspect of the disclosure, an antenna includes a first radiator having a patch shape, a plurality of feed structures configured to feed the first radiator, and a plurality of ports connected to the plurality of feed structures, respectively, wherein each of the plurality of feed structures includes an L-shaped microstrip line.

According to another aspect of the disclosure, an antenna includes a first radiator having a patch shape, a plurality of feed structures configured to feed the first radiator, and a plurality of ports connected to the plurality of feed structures, respectively, wherein the first radiator is configured to output a sum pattern and a difference pattern through each of the plurality of ports, and the sum pattern and the difference pattern are used to detect a direction of a mono pulse.

According to another aspect of the disclosure, an electronic device includes an antenna and at least one processor, wherein the antenna includes a first radiator having a patch shape, a plurality of feed structures configured to feed the first radiator, and a plurality of ports connected to the plurality of feed structures, respectively, the first radiator is configured to transfer a sum pattern and a difference pattern to the at least one processor through each of the plurality of ports, and the at least one processor is configured to detect a direction of a mono pulse based on the sum pattern and the difference pattern.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a ultra-wide band (UWB) system in which UWB signals are transmitted and received, according to an embodiment of the disclosure;

FIG. 2 is a block diagram of an electronic device according to an embodiment of the disclosure;

FIG. 3 is a perspective view illustrating an antenna according to an embodiment of the disclosure;

FIG. 4 is a diagram illustrating a lower portion of an antenna according to an embodiment of the disclosure;

FIG. 5 is a side view of an antenna according to an embodiment of the disclosure;

FIG. 6 is a graph of reflection coefficients according to frequencies of an antenna, according to an embodiment of the disclosure;

FIG. 7 is a perspective view illustrating indirect feeding of an antenna according to an embodiment of the disclosure;

FIG. 8 is a circuit diagram illustrating indirect feeding of an antenna according to an embodiment of the disclosure;

FIG. 9 is a side view illustrating a cavity structure of an antenna according to an embodiment of the disclosure;

FIG. 10 is a graph of gains according to directions of an antenna according to an embodiment of the disclosure;

FIG. 11 is a diagram illustrating outputting a sum pattern and a difference pattern according to an input by each of a plurality of ports of an antenna according to an embodiment of the disclosure;

FIG. 12 is a diagram illustrating respectively inputting signals of a same phase to a plurality of ports of an antenna, according to an embodiment of the disclosure;

FIG. 13 is a graph of a sum pattern and a difference pattern that are output in a case in which signals of a same phase are input to a plurality of ports of an antenna, respectively, according to an embodiment of the disclosure;

FIG. 14 is a diagram illustrating inputting signals of opposite phases to a plurality of ports of an antenna, respectively, according to an embodiment of the disclosure;

FIG. 15 is a graph of a sum pattern and a difference pattern that are output in a case in which signals of opposite phases are input to a plurality of ports of an antenna, respectively, according to an embodiment of the disclosure;

FIG. 16 is a graph of gain according to angles of a sum pattern of an antenna, according to an embodiment of the disclosure;

FIG. 17 is a graph of gain according to angles of difference patterns of an antenna, according to an embodiment of the disclosure;

FIG. 18 is a graph of size ratios of mono pulses according to directions of arrival (DoAs) of an antenna, according to an embodiment of the disclosure;

FIG. 19 is a perspective view illustrating an antenna according to an embodiment of the disclosure;

FIG. 20 is a diagram illustrating a lower portion of an antenna according to an embodiment of the disclosure;

FIG. 21 is a diagram illustrating a feeding current path of an antenna according to an embodiment of the disclosure;

FIG. 22 is a diagram illustrating a flow of current fed to an antenna, according to an embodiment of the disclosure;

FIG. 23 is a graph of reflection coefficients according to frequencies of an antenna, according to an embodiment of the disclosure;

FIG. 24 is a graph of gain according to angles of a sum pattern of an antenna, according to an embodiment of the disclosure;

FIG. 25 is a graph of gain according to angles of difference patterns of an antenna, according to an embodiment of the disclosure; and

FIG. 26 is a graph of size ratios of mono pulses according to DoAs of an antenna, according to an embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The description of the following examples should not be construed as limiting the scope of rights, and what a person skilled in the art can easily infer should be interpreted as falling within the scope of rights of the embodiments. Hereinafter, embodiments for illustrative purposes only will be described in detail with reference to the accompanying drawings.

Hereinafter, embodiments will be described in detail with reference to the accompanying drawings. In the following drawings, the same reference numerals refer to the same components, and the size of each component in the drawings may be exaggerated for clarity and convenience of explanation. Meanwhile, the embodiments described below are merely illustrative, and various modifications are possible from these embodiments.

Hereinafter, the term “over” or “on” may include not only those immediately above, below, left, and right in contact, but also those above, below, left, and right in a non-contact manner. An expression used in the singular may encompass the expression in the plural, unless it has a clearly different meaning in the context. Alternatively, when a part may “include” a certain element, the part may further include another element instead of excluding the other element, unless otherwise stated.

The use of the term “the” and similar referential terms may refer to both the singular and the plural. Unless the order of the steps constituting the method is clearly stated or stated to the contrary, these steps may be performed in any appropriate order and are not necessarily limited to the order described.

Alternatively, terms such as “ . . . unit” and “module” used in the specification refer to a unit that processes at least one function or operation, which may be implemented as hardware or software, or as a combination of hardware and software.

The connections or connection members of lines between components shown in the drawings illustrate functional connections and/or physical or circuit connections, and in actual devices, various functional connections, physical connections, or may be represented as circuit connections.

An expression such as “at least one of” preceding a list of elements qualifies the entire list of elements, not individual elements in the list. For example, expressions such as “at least one of A, B, and C” or “at least one selected from the group consisting of A, B, and C” could be interpreted as A only, B only, C only, or any combination of two or more of A, B, and C, such as ABC, AB, BC, and AC.

When “approximately” or “substantially” is used in connection with a numerical value, the relevant numerical value may be interpreted to include a manufacturing or operating variance (e.g., +10%) around the stated numerical value. Alternatively, when the terms “generally” and “substantially” are used with reference to a geometric shape, it may be intended that geometrical constraints are not required and that latitude for the shape is within the scope of the present embodiment. Alternatively, whether or not the values or figures are limited to “approximately” or “substantially”, such values and figures shall be construed to include manufacturing or operating variations (e.g., +10%) around the stated figures.

While such terms as “first” and “second” may be used to describe various components, such components may not be limited to the above terms. The terms may be used only to distinguish one component from another component.

The use of all examples or illustrative terms is simply for illustrating the technical idea in detail, and the scope is not limited by these examples or illustrative terms unless limited by the claims.

Hereinafter, embodiments for illustrative purposes only may be described in detail with reference to the accompanying drawings.

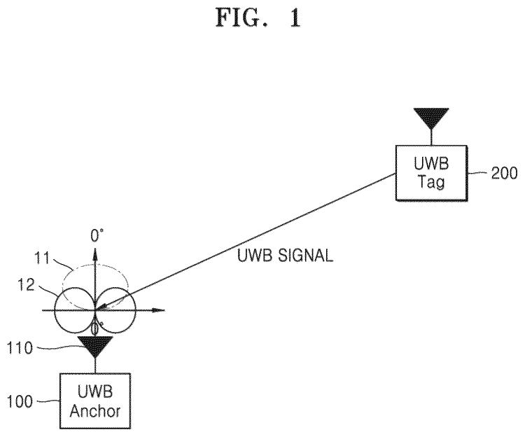

FIG. 1 is a diagram illustrating an ultra-wide band (UWB) system in which UWB signals are transmitted and received, according to an embodiment of the disclosure. The UWB system according to an embodiment may include a UWB anchor 100 and a UWB tag 200.

The UWB tag 200 may provide location information to the UWB anchor 100. Hereinbelow, it is assumed that, when the UWB tag 200 transmits a signal to the UWB anchor 100, the UWB anchor 100 detects a distance from the UWB tag 200 and a direction toward the UWB tag 200, based on the received signal.

The UWB anchor 100 may measure a distance between the UWB anchor 100 and the UWB tag 200. For example, the UWB anchor 100 may measure a distance from the UWB tag 200 by a two-way ranging (TWR) method using a time of flight (ToF), which is a time during which a signal is transmitted and received between the UWB anchor 100 and the UWB tag 200.

The UWB anchor 100 may find a direction in which the UWB anchor 100 faces the UWB tag 200. For example, the UWB anchor 100 may receive a signal by using an antenna having two or more different beam patterns, and find a direction based on a channel impulse response (CIR) of the received signal. When there is a difference in the beam pattern of the antenna, a direction of the UWB tag 200 transmitting the signal may be found by using a difference occurring in the CIR, depending on the direction from which the signal is received.

The UWB anchor 100 according to an embodiment of the present disclosure may include an antenna 110 having a plurality of different beam patterns 11 and 12. The antenna 110 of the UWB anchor 100 may form the plurality of beam patterns 11 and 12. For example, the antenna 110 may form the first beam pattern 11 in a microstrip shape and the second beam pattern 12 in a monopole shape.

The antenna 110 may form the first beam pattern 11 and the second beam pattern 12 simultaneously or alternately. For example, when the UWB anchor 100 includes a corresponding receiver for each beam pattern, the antenna 110 may receive signals while simultaneously forming the plurality of beam patterns 11 and 12. For example, when the UWB anchor 100 includes only one receiver, the antenna 110 may alternately form the plurality of beam patterns 11 and 12 through switching so as to receive signals through one beam pattern at a time.

The antenna 110 may have a structure for forming a plurality of different beam patterns. For example, the antenna 110 may be a single radiator multiple port (SRMP) antenna, in which a plurality of feeding ports are formed in one radiator.

The UWB tag 200 may transmit UWB signals. The UWB anchor 100 may receive a UWB signal by using the antenna 110 forming the plurality of beam patterns 11 and 12. The UWB anchor 100 may obtain a CIR for each of the plurality of beam patterns 11 and 12. Based on the obtained CIR, the UWB anchor 100 may find a direction toward the UWB anchor 100 from the UWB anchor 100.

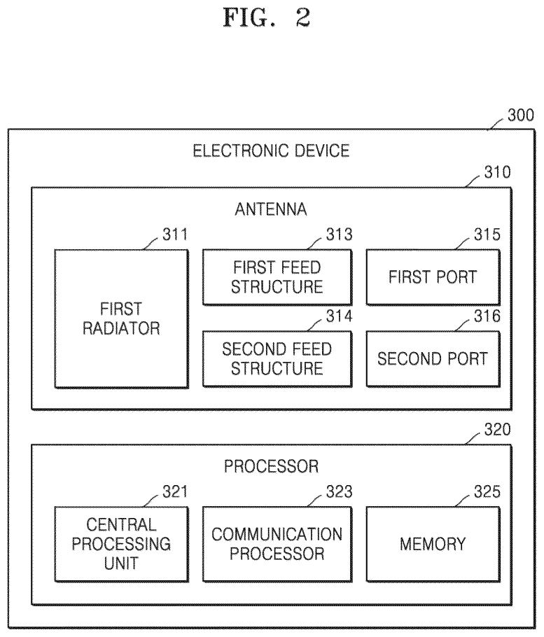

FIG. 2 is a block diagram of an electronic device 300 according to an embodiment of the disclosure. For example, the electronic device 300 may be the UWB anchor 100 of FIG. 1. However, the disclosure is not limited thereto, and the electronic device 300 may be a device for transmitting and receiving UWB signals to implement UWB direction finding technology.

The electronic device 300 according to an embodiment of the disclosure may include an antenna 310 and a processor 320. The antenna 310 of the electronic device 300 may be the antenna 110 of FIG. 1. However, the disclosure is not limited thereto, and the antenna 310 may be a structure for transmitting and receiving UWB signals to implement UWB direction finding technology. The antenna 310 may include a first radiator 311, a plurality of feed structures 313 and 314, and a plurality of ports 315 and 316.

The first radiator 311 may have a patch shape. The first radiator 311 may radiate UWB signals.

The plurality of feed structures 313 and 314 may feed the first radiator 311. For example, the plurality of feed structures 313 and 314 may include the first feed structure 313 and the second feed structure 314. Each of the plurality of feed structures 313 and 314 may include an L-shaped microstrip line. The plurality of feed structures 313 and 314 may transfer signals having the same phase to the plurality of ports 315 and 316, respectively. The plurality of feed structures 313 and 314 may transfer signals having the same phase and detect a direction of a mono pulse.

The plurality of ports 315 and 316 may be connected to the plurality of feed structures 313 and 314, respectively. For example, the plurality of ports 315 and 316 may include the first port 315 and the second port 316. The first port 315 may be connected to the first feed structure 313. The second port 316 may be connected to the second feed structure 314.

The antenna 310 according to an embodiment of the disclosure may be an SRMP antenna in which a plurality of ports are connected to one radiator. The antenna 310 according to an embodiment of the disclosure may miniaturize an existing array antenna for direction finding. The plurality of feed structures 313 and 314 may transfer signals having the same phase to the plurality of ports 315 and 316, respectively.

The processor 320 may include a central processing unit (CPU) 321, a communication processor (CP) 323, and a memory 325. The processor 320 may control overall operations of the electronic device 300. The processor 320 may be electrically connected to the antenna 310. The processor 320 may obtain a UWB signal received by the antenna 310. The processor 320 may analyze the UWB signal received by the antenna 310.

The first radiator 311 may transfer a sum pattern and a difference pattern to the processor 320 through each of the plurality of ports 315 and 316. The sum pattern may be a signal pattern that represents the sum of UWB signals respectively received through the plurality of ports 315 and 316. The difference pattern may be a signal pattern that represents a difference between the UWB signals respectively received through the plurality of ports 315 and 316.

The processor 320 may detect a direction of a mono pulse based on the sum pattern and the difference pattern. The processor 320 may derive the sum pattern and the difference pattern by feeding a single first radiator 311 through the plurality of ports 315 and 316.

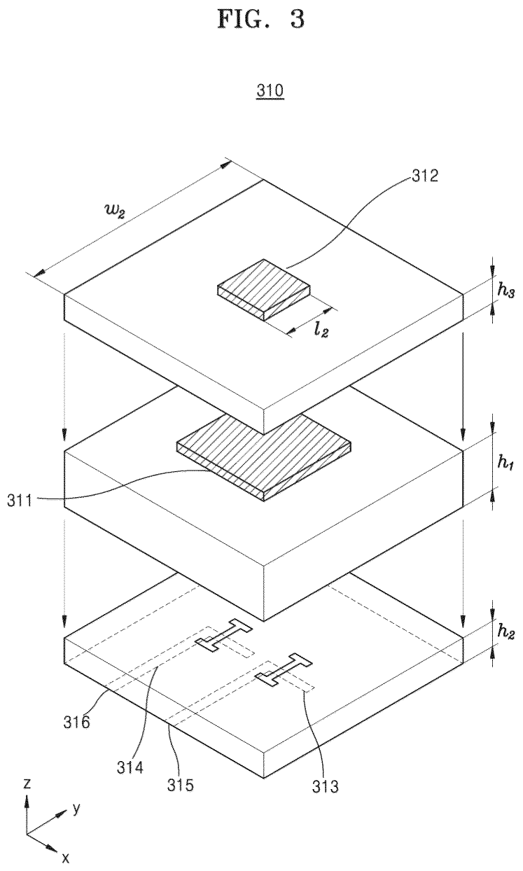

FIG. 3 is a perspective view illustrating the antenna 310 according to an embodiment of the disclosure. The antenna 310 according to an embodiment of the disclosure may include the first radiator 311, a second radiator 312, the first feed structure 313, the second feed structure 314, the first port 315, and the second port 316.

The first radiator 311 may have a patch shape. For example, the first radiator 311 may have a rectangular patch shape. The first radiator 311 may be mounted on a substrate having a first height h₁. The first radiator 311 may transmit and receive UWB signals. The first radiator 311 may form a beam pattern for transmitting and receiving UWB signals. The first radiator 311 may output a sum pattern and a difference pattern through the first port 315 and the second port 316. The sum pattern and the difference pattern may be used to detect a direction of a mono pulse.

The second radiator 312 may be spaced apart from the first radiator 311. The second radiator 312 may be spaced apart from the first radiator 311 in a z-axis direction (upward direction). The second radiator 312 may have a patch shape. For example, the second radiator 312 may have a rectangular patch shape. The second radiator 312 may differ in size from the first radiator 311. For example, a length of the second radiator 312 in a y-axis direction (lateral direction) may be a second length 12. The second length 12 may be different from a length of the first radiator 311 in the y-axis direction. The second radiator 312 may be mounted on a substrate having a third height h₃. The second radiator 312 may be coupled to the first radiator 311. The antenna 310 according to an embodiment of the disclosure may be improved in terms of band characteristics by using the second radiator 312 that is different in size from the first radiator 311.

The first feed structure 313 may feed the first radiator 311. The first feed structure 313 may be positioned in a −z-axis direction (downward direction) from the first radiator 311. The first feed structure 313 may be mounted under a substrate having a second height h₂. The first feed structure 313 may include an L-shaped microstrip line. In the antenna 310 according to an embodiment of the disclosure, an L-shaped microstrip line feed is applied for direction finding using one radiator.

The second feed structure 314 may feed the first radiator 311. The second feed structure 314 may be positioned in the −z-axis direction from the first radiator 311. The second feed structure 314 may be mounted under a substrate on which the first feed structure 313 is mounted, so as to be spaced apart from the first feed structure 313. The second feed structure 314 may include an L-shaped microstrip line. The second feed structure 314, which is an H-shaped slot, may be coupled to the first radiator 311. The second feed structure 314 may indirectly feed the first radiator 311.

The first port 315 may be connected to the first feed structure 313. The first port 315 may be arranged at one end of the first feed structure 313. The first port 315 may transfer a current supplied to the first radiator 311 to the first feed structure 313. An output pattern may vary depending on the phase in which the first port 315 is fed. For example, when the first port 315 is fed in-phase, a sum pattern may be output. For example, when the first port 315 is fed out-phase, a difference pattern may be output.

The second port 316 may be connected to the second feed structure 314. The second port 316 may be arranged at one end of the second feed structure 314. The second port 316 may transfer a current supplied to the first radiator 311 to the second feed structure 314. An output pattern may vary depending on the phase in which the second port 316 is fed. For example, when the second port 316 is fed in-phase, a sum pattern may be output. For example, when the second port 316 is fed out-phase, a difference pattern may be output.

When the first port 315 and the second port 316 are fed in-phase, a sum pattern may be output, and when the first port 315 and the second port 316 are fed out-phase, a difference pattern may be output.

The antenna 310 according to an embodiment of the disclosure may be an SRMP antenna in which two ports are connected to one patch radiator, to miniaturize an array antenna for direction finding. The antenna 310 according to an embodiment of the disclosure may find a direction in which a UWB signal is incident, by using one radiator instead of an array antenna including a plurality of radiators.

In particular, the antenna 310 according to an embodiment of the disclosure may be less in area than when the antenna 310 has the same number of feed structures. For example, in an antenna in which two elements are arranged, each of the elements that are individually arranged may generally have a radiator half a wavelength in size, and may be designed to have an array separation distance of half a wavelength. An overall area of the radiator of an antenna in which two elements are arranged may be one wavelength or more. Accordingly, with an existing array antenna structure, it is not easy to satisfy UWB direction finding miniaturization conditions (a size of one wavelength or less, a bandwidth of at least 500 MHz for UWB direction finding, and mutual coupling characteristics of −10 dB or less to reduce signal distortion). The antenna 310 according to an embodiment of the disclosure may have a size of half a wavelength through the SRMP structure, thereby enabling UWB direction finding while being effectively reduced in area.

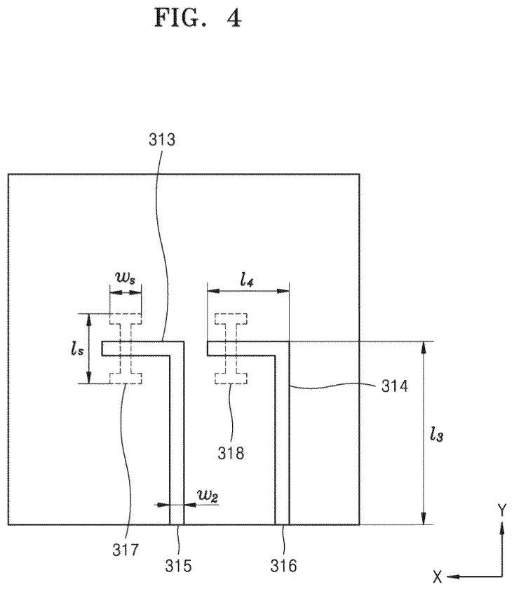

FIG. 4 is a diagram illustrating a lower portion of the antenna 310 according to an embodiment of the disclosure. The first feed structure 313, the second feed structure 314, the first port 315, the second port 316, a first slot 317, and a second slot 318 may be disposed under the antenna 310 according to an embodiment of the disclosure.

The first feed structure 313 may include an L-shaped microstrip line. The L-shaped microstrip line may have a second width w₂. The L-shaped microstrip line may have a third length l₃ in the y-axis direction. The L-shaped microstrip line may be bent in the x-axis direction (front side direction) at a portion extending from the first port 315 in the y-axis direction by the third length l₃. The L-shaped microstrip line may have a fourth length 14 in the x-axis direction.

The second feed structure 314 may include an L-shaped microstrip line. The L-shaped microstrip line may have the second width w₂. The L-shaped microstrip line may have the third length l₃ in the y-axis direction. The L-shaped microstrip line may be bent in the x-axis direction at a portion extending from the first port 315 in the y-axis direction by the third length l₃. The L-shaped microstrip line may have the fourth length 14 in the x-axis direction.

The first port 315 may be arranged at one end of the first feed structure 313. The second port 316 may be arranged at one end of the second feed structure 314.

The first slot 317 may be arranged at the other end of the first feed structure 313. The first slot 317 may be H-shaped. The first slot 317 may have a specified length lₛ and a specified width wₛ. The first slot 317 may couple the first feed structure 313 to the first radiator 311. The first slot 317 may allow the first feed structure 313 to indirectly feed the first radiator 311.

The second slot 318 may be arranged at the other end of the second feed structure 314. The second slot 318 may be have an H-shape. The second slot 318 may have the specified length lₛ and the specified width wₛ. The second slot 318 may couple the second feed structure 314 to the first radiator 311. The second slot 318 may allow the second feed structure 314 to indirectly feed the first radiator 311.

In the antenna 310 according to an embodiment of the disclosure, an indirect feed structure using slots may be used to derive wideband characteristics suitable for UWB applications. In the antenna 310 according to an embodiment of the disclosure, an H-shaped slot is applied to improve matching characteristics. In the antenna 310 according to an embodiment of the disclosure, an indirect feeding patch structure that takes into account wideband characteristics and gain characteristics is applied.

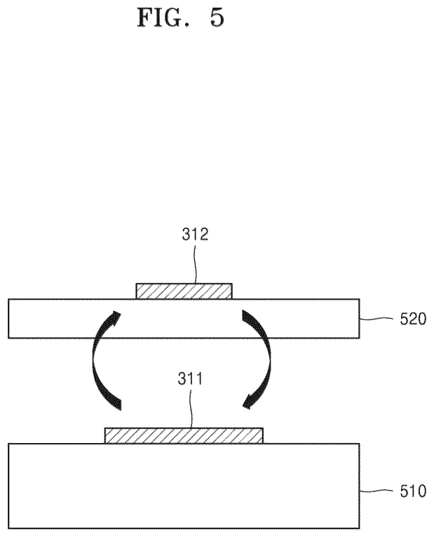

FIG. 5 is a side view of the antenna 310 according to an embodiment of the disclosure. The antenna 310 according to an embodiment of the disclosure may include the first radiator 311, the second radiator 312, a first dielectric layer 510, and a second dielectric layer 520.

The first radiator 311 may be mounted on a surface of the first dielectric layer 510. The second radiator 312 may be mounted on a surface of the second dielectric layer 520. The first radiator 311 and the second radiator 312 may be coupled to each other.

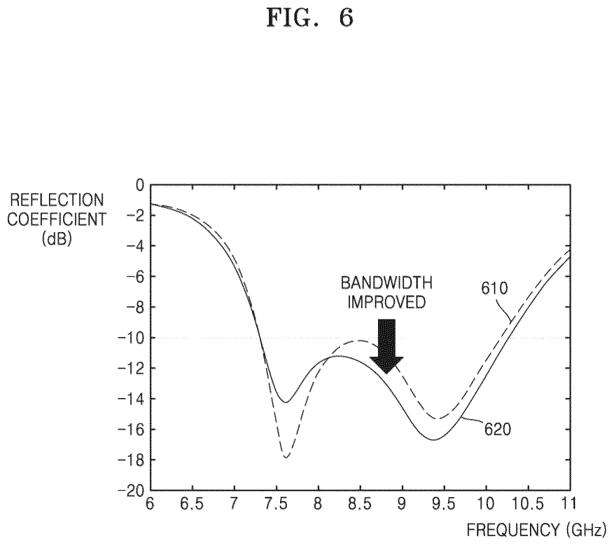

FIG. 6 is a graph of reflection coefficients according to frequencies of the antenna 310, according to an embodiment of the disclosure.

A first graph 610 shows coefficients according to frequencies of the antenna 310 including the first radiator 311, the first feed structure 313, and the second feed structure 314. A second graph 620 shows coefficients according to frequencies of the antenna 310 in which the first slot 317, the second slot 318, and the second radiator 312 are additionally arranged. When the second radiator 312 is additionally arranged, it can be seen that bandwidth characteristics of the antenna 310 are improved. In the antenna 310 according to an embodiment of the disclosure, a slot-coupled feed structure may be applied so as to have wideband characteristics suitable for band 9 (frequency band of 7.7 GHz to 8.2 GHz) from among UWB bands. In the antenna 310 according to an embodiment of the disclosure, a dielectric laminated structure may be applied to have wideband characteristics suitable for band 9 among the UWB bands.

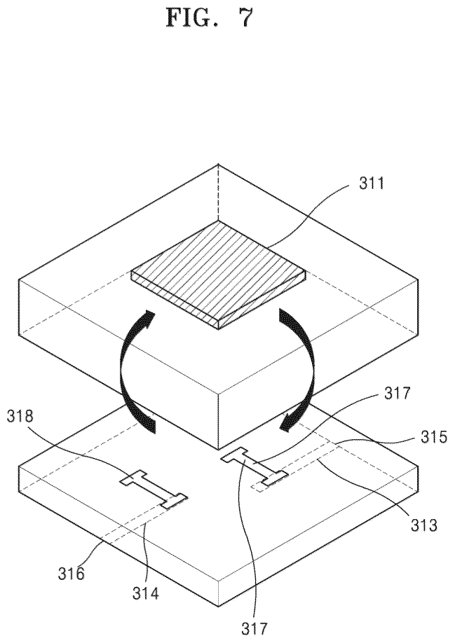

FIG. 7 is a perspective view illustrating indirect feeding of the antenna 310 according to an embodiment of the disclosure. The antenna 310 according to an embodiment of the disclosure may include the first radiator 311, the first feed structure 313, the second feed structure 314, the first port 315, the second port 316, the first slot 317, and the second slot 318.

The first feed structure 313 and the second feed structure 314 may be coupled to the first radiator 311. The first feed structure 313 may be coupled to the first radiator 311 through the first slot 317. The second feed structure 314 may be coupled to the first radiator 311 through the second slot 318. The first feed structure 313 and the second feed structure 314 may indirectly feed the first radiator 311.

In particular, the first feed structure 313 and the second feed structure 314 may have the same polarization direction in the first radiator 311. The first feed structure 313 and the second feed structure 314 may perform feeding of the same polarization for direction finding.

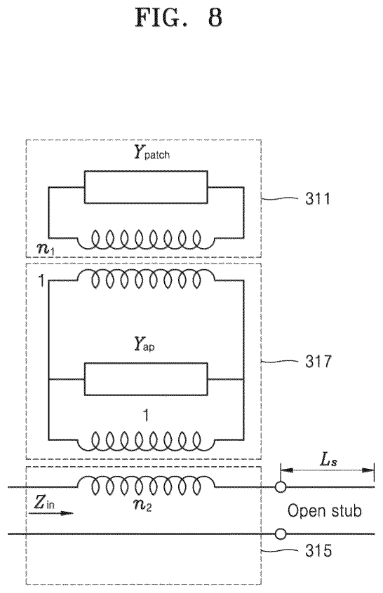

FIG. 8 is a circuit diagram illustrating indirect feeding of the antenna 310 according to an embodiment of the disclosure.

The first radiator 311 may have a specified admittance Y_{patch} and a coupling circuit. The first radiator 311 may be coupled to the first slot 317 with a turn ratio of a first number n₁ to 1 (n1:1).

The first slot 317 may have a specified admittance Yap and a coupling circuit. The first slot 317 may be coupled to the first radiator 311 with a turn ratio of 1 to the first number n₁ (1:n₁). The first slot 317 may be coupled to the first port 315 with a turn ratio of 1 to a second number n₂ (1:n₂).

The first port 315 may have a specified input impedance Zin and a coupling circuit. The first slot 317 may be coupled to the first port 315 with a turn ratio of the second number n₂ to 1 (n₂:1). The first port 315 may be connected to an open stub having the specified length lₛ.

The first feed structure 313 may be coupled to the first radiator 311 through the first slot 317. The first feed structure 313 may indirectly feed the first radiator 311 through the first slot 317.

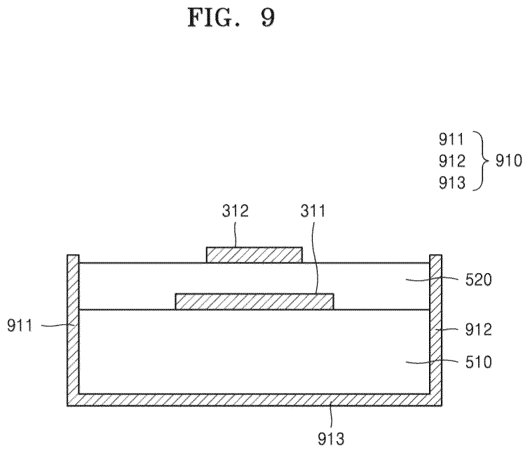

FIG. 9 is a side view illustrating a cavity structure 910 of the antenna 310 according to an embodiment of the disclosure. The antenna 310 according to an embodiment of the disclosure may include the first radiator 311, the second radiator 312, the first dielectric layer 510, the second dielectric layer 520, and the cavity structure 910.

The cavity structure 910 may be spaced apart from the first radiator 311. The cavity structure 910 may be arranged to surround the first dielectric layer 510 and the second dielectric layer 520. The cavity structure 910 may include a conductive material such as a copper plate. The cavity structure 910 may reduce a leakage electric field that is formed by the first radiator 311 and leaking to a side surface of the first dielectric layer 510. The cavity structure 910 may include a first cavity wall 911, a second cavity wall 912, and a cavity lower surface 913.

The first cavity wall 911 may be arranged to surround at least one side surface of the first radiator 311. The first cavity wall 911 may be arranged to surround left sides of the first dielectric layer 510 and the second dielectric layer 520.

The second cavity wall 912 may be arranged to surround at least one side surface of the first radiator 311. The second cavity wall 912 may be arranged to surround right sides of the first dielectric layer 510 and the second dielectric layer 520.

The cavity lower surface 913 may be disposed under the first radiator 311. The cavity lower surface 913 may be arranged to surround the lower surface of the first dielectric layer 510.

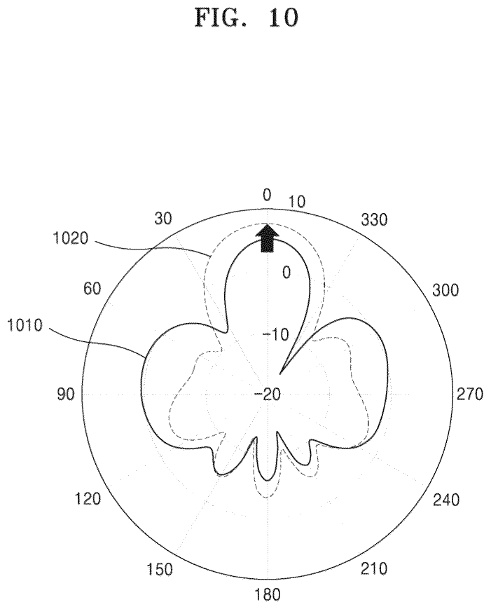

FIG. 10 is a graph of gains according to directions of the antenna 310 according to an embodiment of the disclosure.

The antenna 310 according to an embodiment of the disclosure may have gain that varies depending on the direction. A first graph 1010 shows gains according to a direction of the antenna 310 including the first radiator 311, the second radiator 312, the first dielectric layer 510, and the second dielectric layer 520. A second graph 1020 shows gains according to a direction of the antenna 310 in which the cavity structure 910 is additionally arranged. When the cavity structure 910 is additionally arranged, it can be seen that gain characteristics of the antenna 310 in a front side direction (0 degrees) is improved. In the antenna 310 according to an embodiment of the disclosure, the cavity structure 910 may be applied so that gain characteristics in the front side direction may be improved even when a compact first radiator 311 is used.

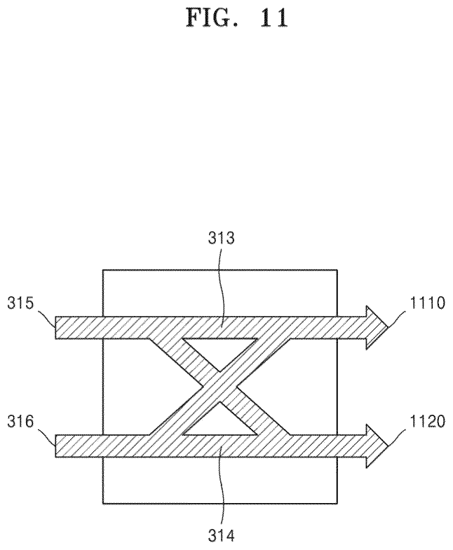

FIG. 11 is a diagram illustrating outputting a sum pattern 1110 and a difference pattern 1120 according to an input of each of the plurality of ports 315 and 316 of the antenna 310, according to an embodiment of the disclosure.

The antenna 310 according to an embodiment of the disclosure may find a direction in which a UWB signal is incident, through a mono pulse system. To find a direction of the mono pulse, the antenna 310 may transfer signals of the same phase to the first port 315 and the second port 316. The first port 315 and the second port 316 may receive the signals of the same phase. The first port 315 and the second port 316 may output the sum pattern 1110 and the difference pattern 1120 through a plurality of feed structures.

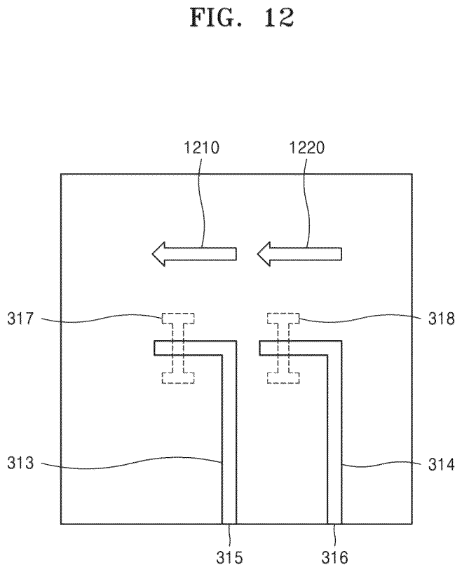

FIG. 12 is a diagram illustrating inputting signals 1210 and 1220 of the same phase to the plurality of ports 315 and 316 of the antenna 310, respectively, according to an embodiment of the disclosure.

The plurality of ports 315 and 316 may receive in-phase feed signals 1210 and 1220 with the same phase, respectively. The first port 315 may feed the first radiator 311 through the first slot 317. The second port 316 may feed the first radiator 311 through the second slot 318.

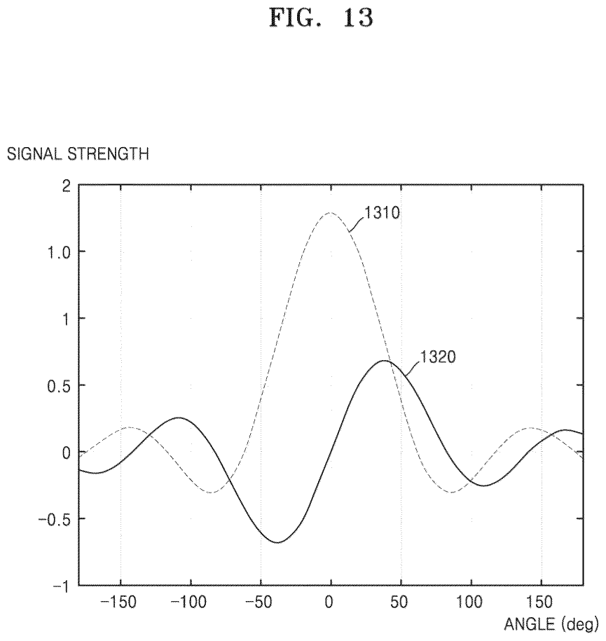

FIG. 13 is a graph of a sum pattern 1310 and a difference pattern 1320 that are output in a case in which signals of a same phase are input to the plurality of ports 315 and 316 of the antenna 310, respectively, according to an embodiment of the disclosure.

When signals of the same phase are input to the plurality of ports 315 and 316, respectively, the sum pattern 1310 may have a maximum signal intensity in the direction to the front side of the antenna 310. When signals of the same phase are input to the plurality of ports 315 and 316, respectively, the difference pattern 1320 may have a zero signal intensity in the direction to the front side of the antenna 310. When signals of the same phase are input to the plurality of ports 315 and 316, respectively, the difference pattern 1320 may have maximum and minimum signal intensities in the 45 degree left and right directions of the antenna 310, respectively.

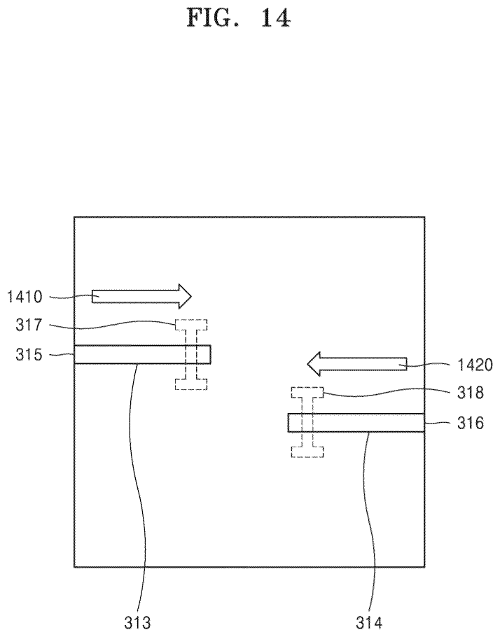

FIG. 14 is a diagram illustrating inputting signals of opposite phases to a plurality of ports of the antenna 310, respectively.

The plurality of ports 315 and 316 may receive out-phase feed signals 1410 and 1420 with opposite phases, respectively. The first port 315 may feed the first radiator 311 through the first slot 317. The second port 316 may feed the first radiator 311 through the second slot 318.

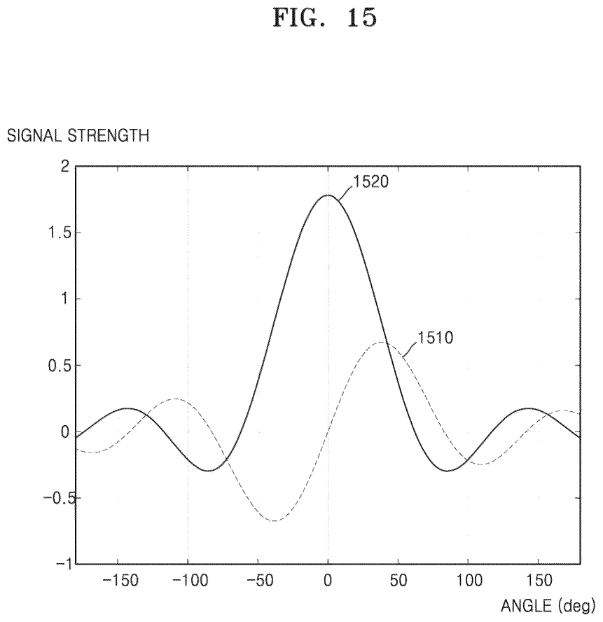

FIG. 15 is a graph of a sum pattern 1510 and a difference pattern 1520 that are output in a case in which signals of opposite phases are input to a plurality of ports of the antenna 310, respectively, according to an embodiment of the disclosure.

When signals of the same phase are input to the plurality of ports 315 and 316, respectively, the sum pattern 1510 may have a zero signal intensity in the direction to the front side of the antenna 310. When signals of opposite phases are input to the plurality of ports 315 and 316, respectively, the sum pattern 1510 may have maximum and minimum signal intensities in the 45 degree left and right directions of the antenna 310, respectively. When signals of opposite phases are input to the plurality of ports 315 and 316, respectively, the difference pattern 1520 may have a maximum signal intensity in the direction to the front side of the antenna 310. When signals of opposite phases are input to the plurality of ports 315 and 316, respectively, a reversed result may be obtained compared to when signals of the same phase are input to the plurality of ports 315 and 316, respectively.

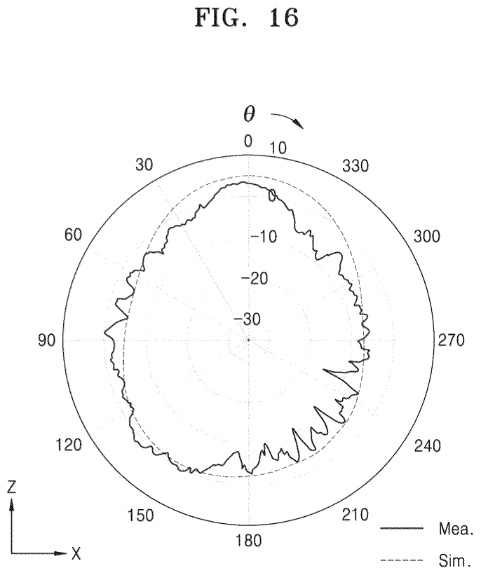

FIG. 16 is a graph of gain according to angles of a sum pattern of the antenna 310, according to an embodiment of the disclosure.

The antenna 310 according to an embodiment of the disclosure may find a direction of a mono pulse by using a radiation pattern according to a direction of a sum pattern. When the radiation pattern according to the direction of the sum pattern of the antenna 310 is analyzed, it can be seen that maximum gain is achieved in the direction to the front side of the antenna 310.

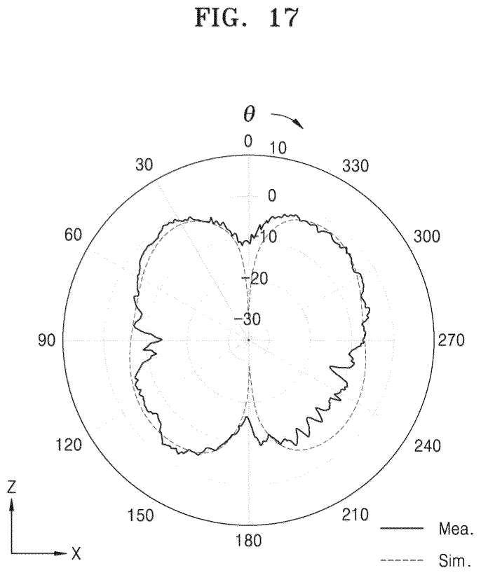

FIG. 17 is a graph of gain according to angles of difference patterns of the antenna 310, according to an embodiment of the disclosure.

The antenna 310 according to an embodiment of the disclosure may find a direction of a mono pulse by using a radiation pattern according to a direction of a difference pattern. When the radiation pattern according to the direction of the difference pattern of the antenna 310 is analyzed, it can be seen that minimum gain is achieved in the direction to the front side of the antenna 310. When the radiation pattern according to the direction of the difference pattern of the antenna 310 is analyzed, it can be seen that maximum gain is achieved in the 45 degree left and right directions of the antenna 310.

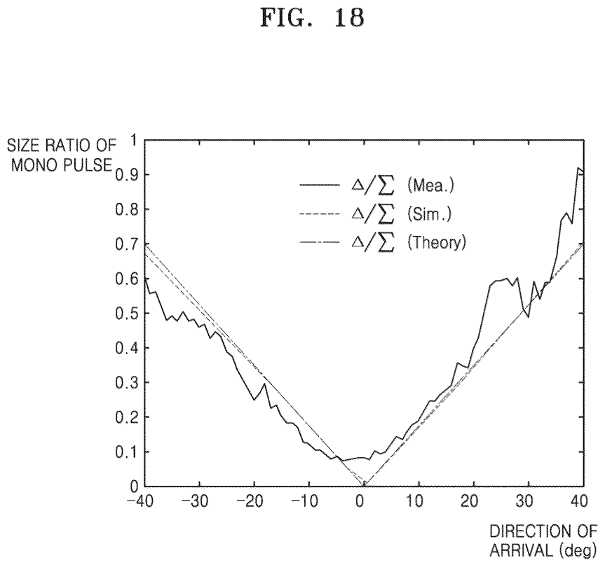

FIG. 18 is a graph of size ratios of mono pulses according to directions of arrival (DoAs) of the antenna 310, according to an embodiment of the disclosure.

The antenna 310 according to an embodiment of the disclosure may calculate a ratio of a sum pattern and a difference pattern to derive a size ratio of a mono pulse according to DoAs. The size ratio of the mono pulse may vary depending on the DoA. For example, when the DoA is a direction to the front side of the antenna 310 (0 degrees), the size ratio of the mono pulse may be 0. For example, when an angle of DoA increases in left and right directions of the antenna 310, the size ratio of the mono pulse may increase. The antenna 310 according to an embodiment of the disclosure may find the direction of the mono pulse based on the size ratio of the mono pulse according to DoA.

In particular, in the direction finding of the mono pulse, direction information of a signal may be extracted through a ratio of a sum pattern and a difference pattern. To this end, the sum pattern may require a feed path of the same phase, and the difference pattern may require a feed path with a phase difference of 180 degrees. In the antenna 310 according to an embodiment of the disclosure, a radiation pattern may be designed under the assumption that calculation of a sum pattern and a difference pattern for a mono pulse is performed theoretically. In the antenna 310 according to an embodiment of the disclosure, a feed structure having the same phase may be designed for application to a general mono pulse system. In the antenna 310 according to an embodiment of the disclosure, for the same-phase-feeding by the first radiator 311, two microstrip lines may be designed in an L-shape identically and may be disposed under a slot.

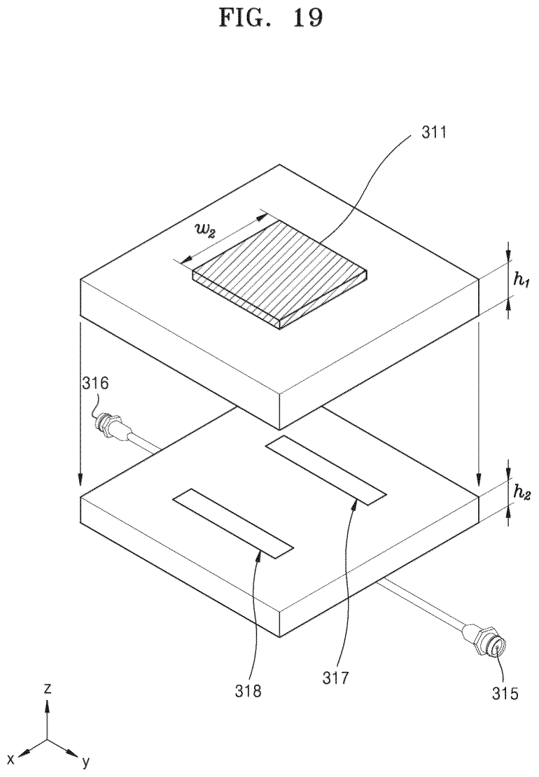

FIG. 19 is a perspective view illustrating the antenna 310 according to an embodiment of the disclosure. The antenna 310 according to an embodiment of the disclosure may include the first radiator 311, the first port 315, the second port 316, the first slot 317, and the second slot 318.

The first radiator 311 may have a rectangular patch shape. The first port 315 and the second port 316 may receive current fed to the first radiator 311. The first slot 317 and the second slot 318 may indirectly feed the first radiator 311. In the antenna 310 according to an embodiment of the disclosure, a sum pattern and a difference pattern may be output from the first radiator 311 to the first port 315 and the second port 316. The antenna 310 according to an embodiment of the disclosure may perform mono pulse direction finding based on the sum pattern and the difference pattern.

On an upper layer of the antenna 310 according to an embodiment of the disclosure, the first radiator 311 may be mounted on a TLY-5 substrate having a thickness of the first height h₁. On a lower layer of the antenna 310, the first slot 317 and the second height h₂ for driving wideband characteristics may be disposed on an upper surface of a TLY-35 substrate having a thickness of the second height h₂. The antenna 310 according to an embodiment of the disclosure may have a structure in which an upper layer and a lower layer may be stacked so that the first slot 317 and the second slot 318 indirectly feed the first radiator 311 on the upper layer.

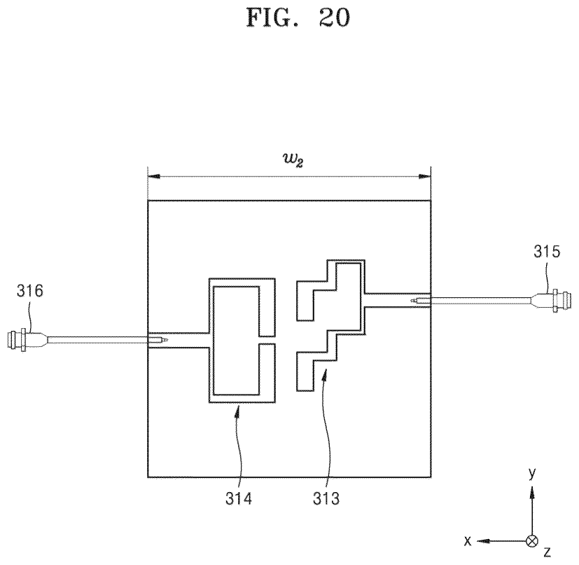

FIG. 20 is a diagram illustrating a lower portion of the antenna 310 according to an embodiment of the disclosure. The first feed structure 313, the second feed structure 314, the first port 315, and the second port 316 may be disposed under the antenna 310 according to an embodiment of the disclosure.

The first feed structure 313 and the second feed structure 314 may include a microstrip line. The first feed structure 313 and the second feed structure 314 may be arranged at opposite sides with respect to the first radiator 311.

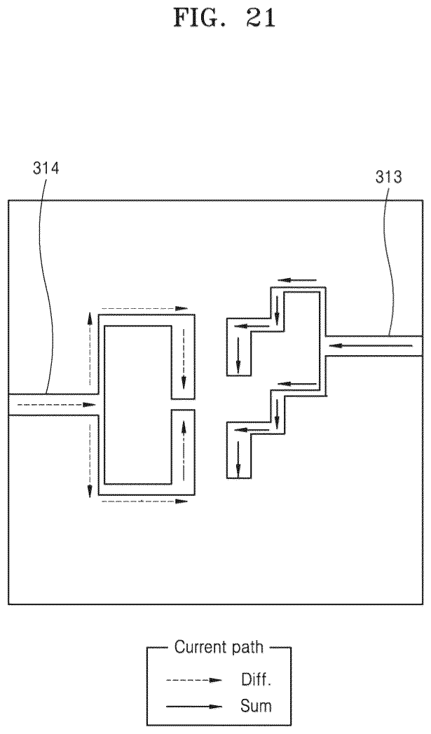

FIG. 21 is a diagram illustrating a feeding current path of the antenna 310 according to an embodiment of the disclosure.

The first feed structure 313 may allow feed current to flow to output a sum pattern. The second feed structure 314 may allow feed current to flow to output a difference pattern.

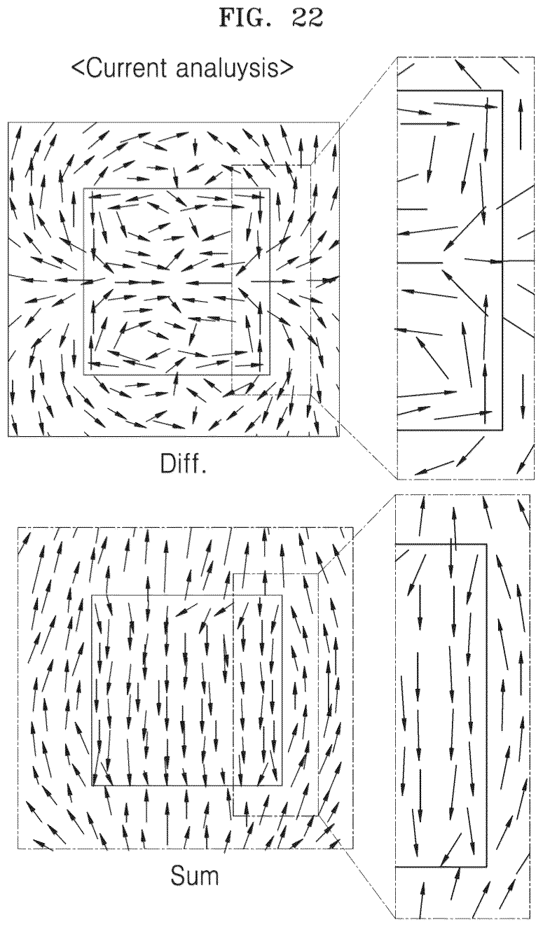

FIG. 22 is a diagram illustrating a flow of current fed to the antenna 310, according to an embodiment of the disclosure.

The first radiator 311 of the antenna 310 according to an embodiment of the disclosure may output a sum pattern, when power is supplied in the same direction from opposite ends of each of the plurality of feed structures 313 and 314. In order to output a sum pattern, the antenna 310 according to an embodiment of the disclosure may allow feed current to be supplied in the same direction from opposite ends of the first feed structure 313 and the second feed structure 314 so that the current flows in one direction from the first radiator 311.

The first radiator 311 of the antenna 310 according to an embodiment of the disclosure may output a difference pattern, when power is supplied in opposite directions from opposite ends of each of the plurality of feed structures 313 and 314. In order to output a difference pattern, the antenna 310 according to an embodiment of the disclosure may allow feed current to be supplied in opposite directions from opposite ends of the first feed structure 313 and the second feed structure 314 so that current flows from the first radiator 311 in opposite directions with respect to a central portion.

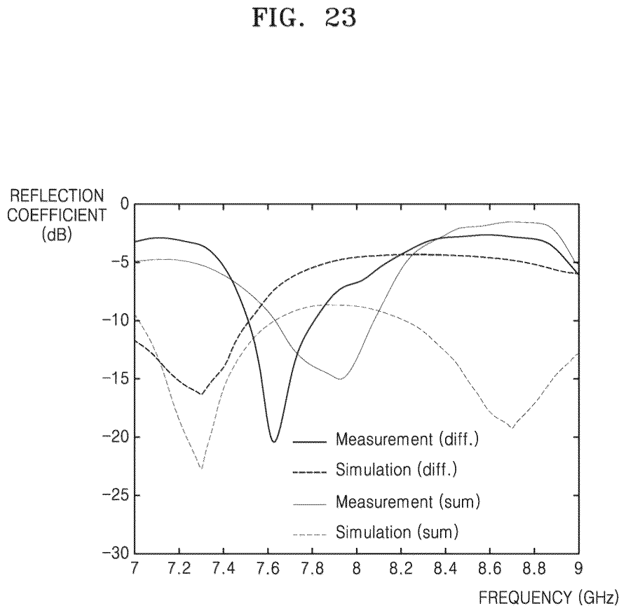

FIG. 23 is a graph of reflection coefficients according to frequencies of the antenna 310, according to an embodiment of the disclosure.

In a sum pattern of the antenna 310 according to an embodiment of the disclosure, it can be seen that a reflection coefficient measured in a frequency band of about 7.8 GHz to about 8.1 GHz is-10 dB or less. In a difference pattern of the antenna 310 according to an embodiment of the disclosure, it can be seen that a reflection coefficient measured in a frequency band of about 7.5 GHz to about 7.8 GHz is-10 dB or less.

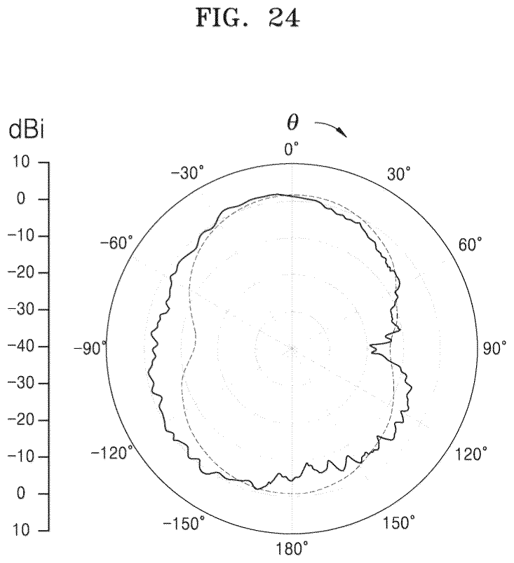

FIG. 24 is a graph of gain according to angles of a sum pattern of the antenna 310, according to an embodiment of the disclosure.

As a result of measuring a sum pattern from among beam patterns of the antenna 310 according to an embodiment of the disclosure, it can be seen that gain in the direction to the front side of the antenna 310 is about 7.4 GHz to about 1.6 dBi. As a result of simulating a sum pattern from among beam patterns of the antenna 310 according to an embodiment of the disclosure, it can be seen that gain in the direction to the front side of the antenna 310 is about 7.4 GHz to about 1.5 dBi.

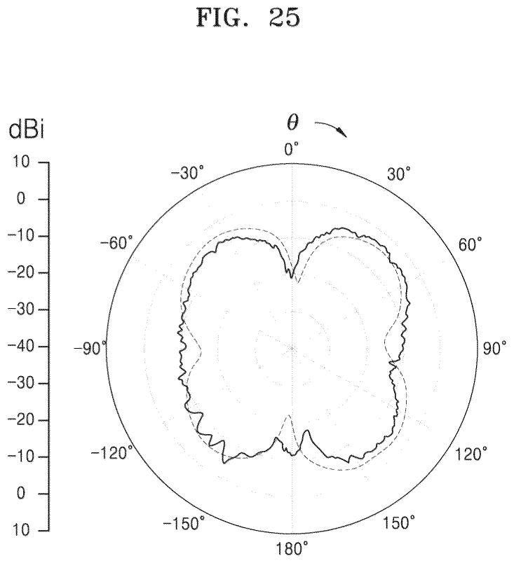

FIG. 25 is a graph of gain according to angles of a difference pattern of the antenna 310, according to an embodiment of the disclosure.

As a result of measuring a difference pattern from among beam patterns of the antenna 310 according to an embodiment of the disclosure, it can be seen that gain in the direction to the front side of the antenna 310 is about 7.4 GHz to about-18.3 dBi. As a result of simulating a difference pattern from among beam patterns of the antenna 310 according to an embodiment of the disclosure, it can be seen that gain in the direction to the front side of the antenna 310 is about 7.4 GHz to about-18.6 dBi.

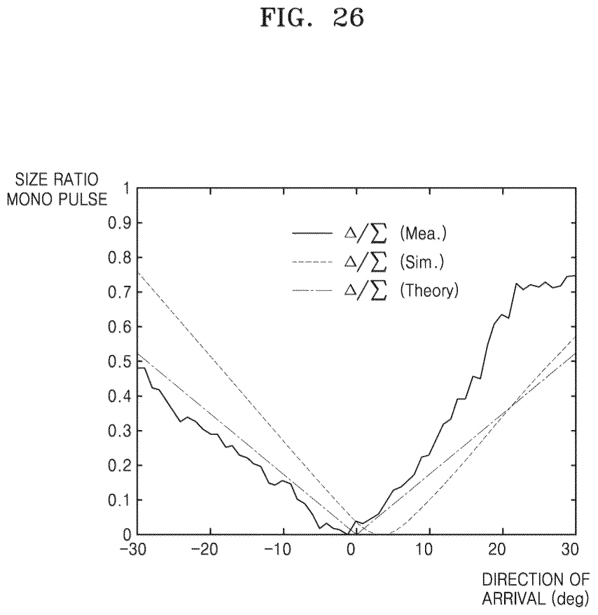

FIG. 26 is a graph of size ratios of mono pulses according to DoAs of the antenna 310, according to an embodiment of the disclosure.

In order to identify a direction finding performance of the antenna 310 according to an embodiment of the disclosure, a mono pulse intensity ratio may be calculated by analyzing radiation shapes and radiation values of a sum pattern and a difference pattern. Root mean square error (RMSE) values of 0.1 and 0.09 are obtained during measurement and simulation, respectively, in a direction range of about −30 degrees to about 30 degrees based on the direction to the front side of the antenna 310, according to an embodiment of the disclosure.

In particular, in the antenna 310 according to an embodiment of the disclosure, a microstrip line for calculating a sum pattern and a difference pattern may be designed and applied. The microstrip line may be designed so that phase values of lines fed to two slots are in phase or 180 degrees out of phase.

The disclosure provides an antenna for finding a direction in which a UWB signal is incident, while being reduced in physical size, and an electronic device including the antenna.

The antenna according to an embodiment of the disclosure may include a first radiator with a patch shape, a plurality of feed structures configured to feed the first radiator, and a plurality of ports connected to the plurality of feed structures, respectively, wherein each of the plurality of feed structures includes an L-shaped microstrip line.

The antenna according to an embodiment of the disclosure may include a second radiator spaced apart from the first radiator, and the second radiator may have the patch shape and may differ in size from the first radiator.

Each of the plurality of feed structures according to an embodiment of the disclosure may be coupled to an H-shaped slot and may indirectly feed the first radiator.

The antenna according to an embodiment of the disclosure may include a first dielectric layer with the first radiator mounted on a surface thereof, and a second dielectric layer with the second radiator mounted on a surface thereof.

The antenna according to an embodiment of the disclosure may include a cavity structure spaced apart from the first radiator, and the cavity structure may include a cavity wall arranged to surround at least one side surface of the first radiator.

The first radiator according to an embodiment of the disclosure may be configured to output a sum pattern and a difference pattern through each of the plurality of ports, and the sum pattern and the difference pattern may be used to detect a direction of a mono pulse.

An antenna according to an embodiment of the disclosure includes a first radiator having a patch shape, a plurality of feed structures configured to feed the first radiator, and a plurality of ports connected to the plurality of feed structures, respectively, wherein the first radiator is configured to output a sum pattern and a difference pattern through each of the plurality of ports, and the sum pattern and the difference pattern may be used to detect a direction of a mono pulse.

The first radiator according to an embodiment of the disclosure may be further configured to output the sum pattern, when power is supplied in the same direction from opposite ends of each of the plurality of feed structures.

The first radiator according to an embodiment of the disclosure may be further configured to output the difference pattern, when power is supplied in opposite directions from opposite ends of each of the plurality of feed structures.

Each of the plurality of feed structures according to an embodiment of the disclosure may be coupled to an H-shaped slot and may indirectly feed the first radiator.

The antenna according to an embodiment of the disclosure may include a first dielectric layer with the first radiator mounted on a surface thereof.

Each of the plurality of feed structures according to an embodiment of the disclosure may include a first feed structure connected to a first port from among the plurality of ports and facing in a first direction from the first radiator, and a second feed structure connected to the first port from among the plurality of ports and facing in a second direction from the first radiator, the second direction being opposite to the first direction.

The first feed structure and the second feed structure according to an embodiment of the disclosure may include microstrip lines.

An electronic device according to an embodiment of the disclosure includes an antenna and at least one processor, wherein the antenna includes a first radiator with a patch shape, a plurality of feed structures configured to feed the first radiator, and a plurality of ports connected to the plurality of feed structures, respectively, the first radiator is configured to transfer a sum pattern and a difference pattern to the at least one processor through each of the plurality of ports, and the at least one processor may detect a direction of a mono pulse based on the sum pattern and the difference pattern.

The first radiator according to an embodiment of the disclosure may be further configured to transfer the sum pattern to the at least one processor, when power is supplied in the same direction from opposite ends of the plurality of feed structures.

The first radiator according to an embodiment of the disclosure may be further configured to transfer the difference pattern to the at least one processor, when power is supplied in opposite directions from opposite ends of each of the plurality of feed structures.

Each of the plurality of feed structures according to an embodiment of the disclosure may be coupled to an H-shaped slot and may indirectly feed the first radiator.

The antenna according to an embodiment of the disclosure may include a first dielectric layer with the first radiator mounted on a surface thereof.

The plurality of feed structures according to an embodiment of the disclosure may include a first feed structure connected to a first port from among the plurality of ports and facing in a first direction from the first radiator, and a second feed structure connected to the first port from among the plurality of ports and facing in a second direction from the first radiator, the second direction being opposite to the first direction.

The first feed structure and the second feed structure according to an embodiment of the disclosure may include microstrip lines.

According to the disclosure, a compact antenna configured to detect a direction in which a UWB signal is incident, the antenna including a plurality of ports in a single radiator, and an electronic device including the antenna may be implemented.

A method according to an embodiment of the disclosure may be embodied as program commands executable by various computer means and may be recorded on a computer-readable recording medium. The computer-readable recording medium may include program commands, data files, data structures, and the like separately or in combinations. The program commands recorded on the computer-readable recording medium may be specially designed and configured for the present disclosure or may be well-known to and be usable by one of ordinary skill in the art of computer software. Examples of the computer-readable recording medium include a magnetic medium such as a hard disk, a floppy disk, or a magnetic tape, an optical medium such as a compact disc read-only memory (CD-ROM) or a digital video disc (DVD), a magneto-optical medium such as a floptical disk, and a hardware device specially configured to store and execute program commands such as a read-only memory (ROM), a random-access memory (RAM), or a flash memory. Examples of the program commands include advanced language codes that may be executed by a computer by using an interpreter or the like as well as machine language codes made by a compiler.

Some embodiments of the disclosure may also be realized in a form of a recording medium including instructions executable by a computer, such as a program module executed by a computer. A computer-readable medium may be an arbitrary available medium accessible by a computer, and includes all volatile and non-volatile media and separable and non-separable media. Further, the computer-readable medium may include both a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. Communication media typically includes computer readable instructions, data structures, program modules, or other data in a modulated data signal, such as a carrier wave, or other transport mechanism, and includes any information delivery media. In addition, some embodiments of the disclosure may also be implemented as a computer program or computer program product including computer-executable instructions, such as a computer program executed by a computer.

A machine-readable storage medium may be provided in a form of a non-transitory storage medium. Here, the “non-transitory storage medium” only denotes a tangible device and does not contain a signal (for example, electromagnetic waves). This term does not distinguish a case where data is stored in the storage medium semi-permanently from a case where the data is stored in the storage medium temporarily. For example, the “non-transitory storage medium” may include a buffer where data is temporarily stored.

According to an embodiment of the disclosure, a method according to various embodiments disclosed in the present document may be provided by being included in a computer program product. The computer program products are products that can be traded between sellers and buyers. The computer program product may be distributed in a form of machine-readable storage medium (for example, a CD-ROM), or distributed (for example, downloaded or uploaded) through an application store or directly or online between two user devices (for example, smartphones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An antenna comprising:
a first radiator having a patch shape;
a plurality of feed structures configured to feed the first radiator; and
a plurality of ports connected to the plurality of feed structures, respectively,
wherein each of the plurality of feed structures comprises an L-shaped microstrip line.

2. The antenna of claim 1, further comprising a second radiator spaced apart from the first radiator,
wherein the second radiator has a patch shape and is different in size from the first radiator.

3. The antenna of claim 1, wherein each of the plurality of feed structures is coupled to an H-shaped slot and indirectly feeds the first radiator.

4. The antenna of claim 1, further comprising:
a first dielectric layer with the first radiator mounted on a surface thereof; and
a second dielectric layer with the second radiator mounted on a surface thereof.

5. The antenna of claim 1, further comprising a cavity structure spaced apart from the first radiator,
wherein the cavity structure comprises a cavity wall arranged to surround at least one side surface of the first radiator.

6. The antenna of claim 1, wherein the first radiator is configured to output a sum pattern and a difference pattern through each of the plurality of ports, and
the sum pattern and the difference pattern are used to detect a direction of a mono pulse.

7. An antenna comprising:
a first radiator having a patch shape;
a plurality of feed structures configured to feed the first radiator; and
a plurality of ports connected to the plurality of feed structures, respectively,
wherein the first radiator is configured to output a sum pattern and a difference pattern through each of the plurality of ports, and
the sum pattern and the difference pattern are used to detect a direction of a mono pulse.

8. The antenna of claim 7, wherein the first radiator is further configured to output the sum pattern when power is supplied in a same direction from opposite ends of each of the plurality of feed structures.

9. The antenna of claim 7, wherein the first radiator is further configured to output the difference pattern when power is supplied in opposite directions from opposite ends of each of the plurality of feed structures.

10. The antenna of claim 7, wherein each of the plurality of feed structures is coupled to an H-shaped slot and indirectly feeds the first radiator.

11. The antenna of claim 7, further comprising a first dielectric layer with the first radiator mounted on a surface thereof.

12. The antenna of claim 7, wherein each of the plurality of feed structures comprises:
a first feed structure connected to a first port from among the plurality of ports and facing in a first direction from the first radiator; and
a second feed structure connected to the first port from among the plurality of ports and facing in a second direction from the first radiator, the second direction being opposite to the first direction.

13. The antenna of claim 12, wherein the first feed structure and the second feed structure each comprise microstrip lines.

14. An electronic device comprising:
an antenna; and
at least one processor,
wherein the antenna comprises:
a first radiator having a patch shape;
a plurality of feed structures configured to feed the first radiator; and
a plurality of ports connected to the plurality of feed structures, respectively,
the first radiator is configured to transfer a sum pattern and a difference pattern to the at least one processor through each of the plurality of ports, and
the at least one processor is configured to detect a direction of a mono pulse based on the sum pattern and the difference pattern.

15. The electronic device of claim 14, wherein the first radiator is further configured to transfer the sum pattern to the at least one processor when power is supplied in a same direction from opposite ends of each of the plurality of feed structures.

16. The electronic device of claim 14, wherein the first radiator is further configured to transfer the difference pattern to the at least one processor when power is supplied in opposite directions from opposite ends of each of the plurality of feed structures.

17. The electronic device of claim 14, wherein each of the plurality of feed structures is coupled to an H-shaped slot and indirectly feeds the first radiator.

18. The electronic device of claim 14, wherein the antenna further comprises a first dielectric layer with the first radiator mounted on a surface thereof.

19. The electronic device of claim 14, wherein the plurality of feed structures comprise:
a first feed structure connected to a first port from among the plurality of ports and facing in a first direction from the first radiator; and
a second feed structure connected to the first port from among the plurality of ports and facing in a second direction from the first radiator, the second direction being opposite to the first direction.

20. The electronic device of claim 19, wherein the first feed structure and the second feed structure each comprise microstrip lines.
